(19) United States
(12) Patent Application Publication
(10) Pub. No.: US 2008/0228315 A1
(43) Pub. Date: Sep. 18, 2008

(54) Display and Operating Unit for a Machine in the Tobacco Processing Industry

(75) Inventors: Jurgen Wendner, Hamburg (DE); Carsten Schmidt, Lutjensee (DE); Michael Klindworth, Reinbek (DE); Marco Mugge, Lauenburg (DE); Andreas Ducci, Escheburg (DE); Henning Thiele, Lauenburg (DE); Karsten Eckert, Hamburg (DE)

Correspondence Address: VENABLE LLP, P.O. BOX 34385, WASHINGTON, DC, 20043-9998, US

(73) Assignee: Hauni Maschninenbau AG, Hamburg (DE)

(21) Appl. No.: 10/569,945

(22) PCT Filed: Aug. 30, 2003
(86) PCT No.: PCT/EP2003/009655

§ 371 Date: May 13, 2008

(51) Int. Cl. G05B 19/409

(52) U.S. Cl. 700/180; 700/17

(57) ABSTRACT

A display and operating unit for a machine in the tobacco-processing industry includes a visual display unit for the display of a graphic user interface consisting of a plurality of screen displays, and a computer which is designed to generate the graphic user interface by means of a computer program, essentially all the screen displays having at least the following regions: an operating region that can be operated by the operator for the display of a plurality of different operating-region displays that can be selected by the operator, with machine- and/or product-related display and operating elements; and a message region for the display of machine- or product-related stop and warning messages. The screen displays have at least one further region which includes machine- and/or product-related display and/or operating elements concerning the production mode, display of the further region being independent of the respectively selected operating-region display of the operating region.

The invention concerns a display and operating unit for a machine in the tobacco-processing industry, with a visual display unit for the display of a graphic user interface consisting of a plurality of screen displays, and a computer which is designed to generate the graphic user interface by means of a computer program, whereby essentially all the screen displays that can be displayed during production have at least the following regions:

an operating region that can be operated by the operator for the display of a plurality of different operating-region displays that can be selected by the operator, with machine- and/or product-related display and operating elements; and a message region for the display of machine- or product-related stop and warning messages. The invention further concerns a corresponding display and operating method.

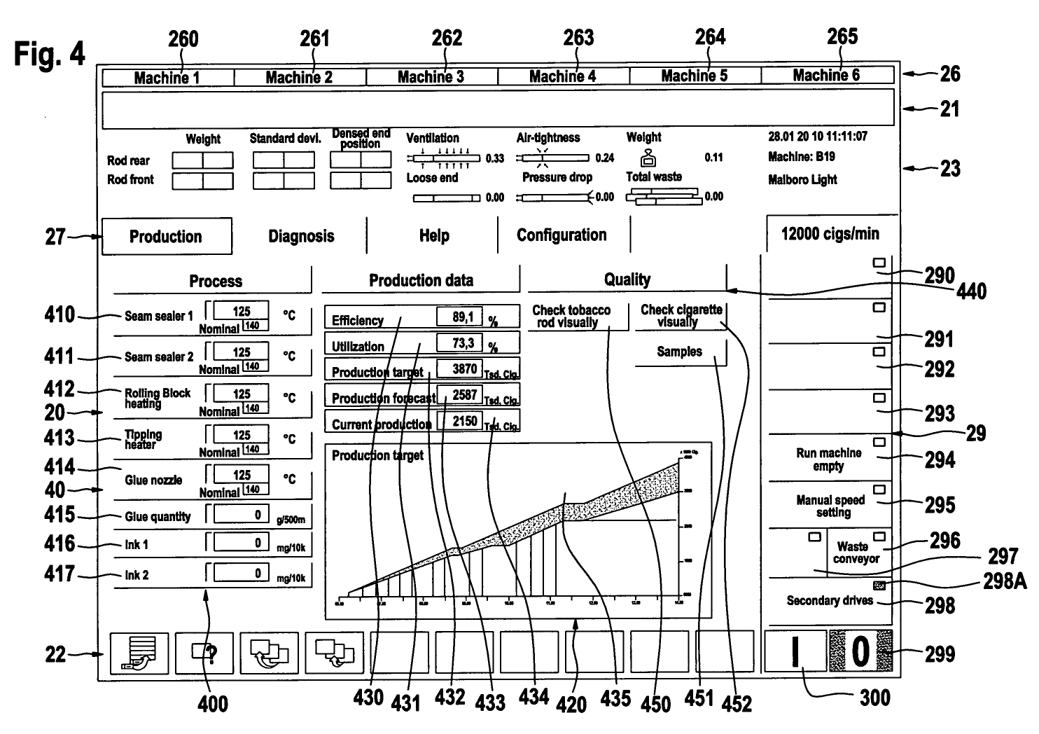

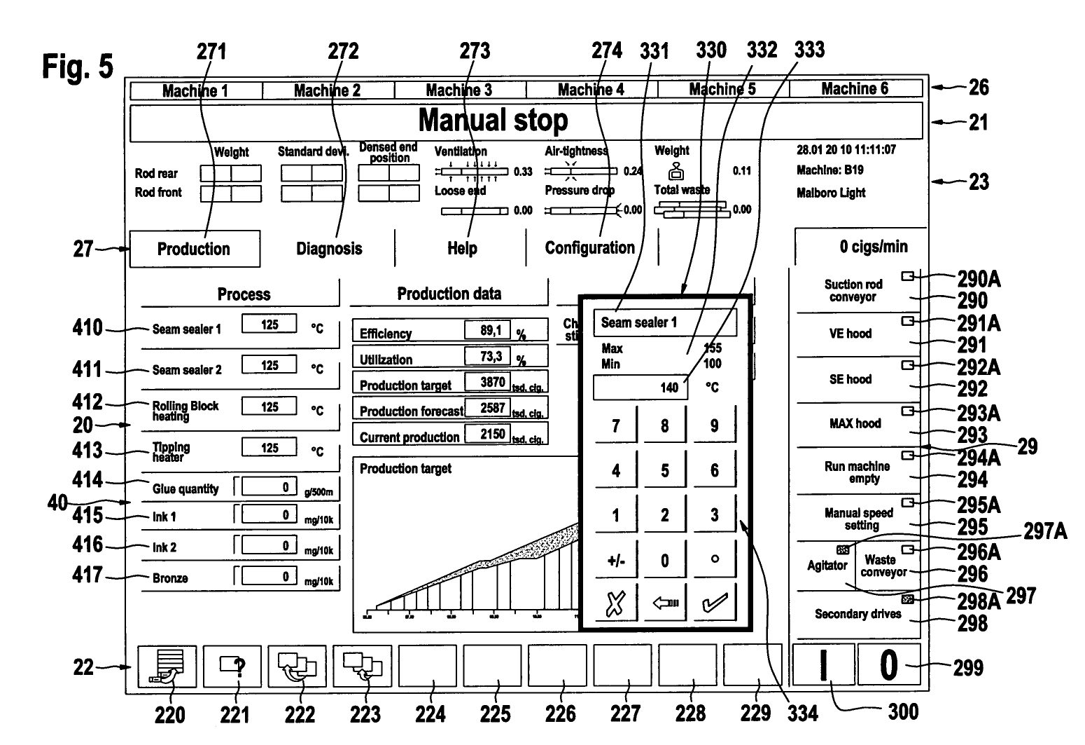

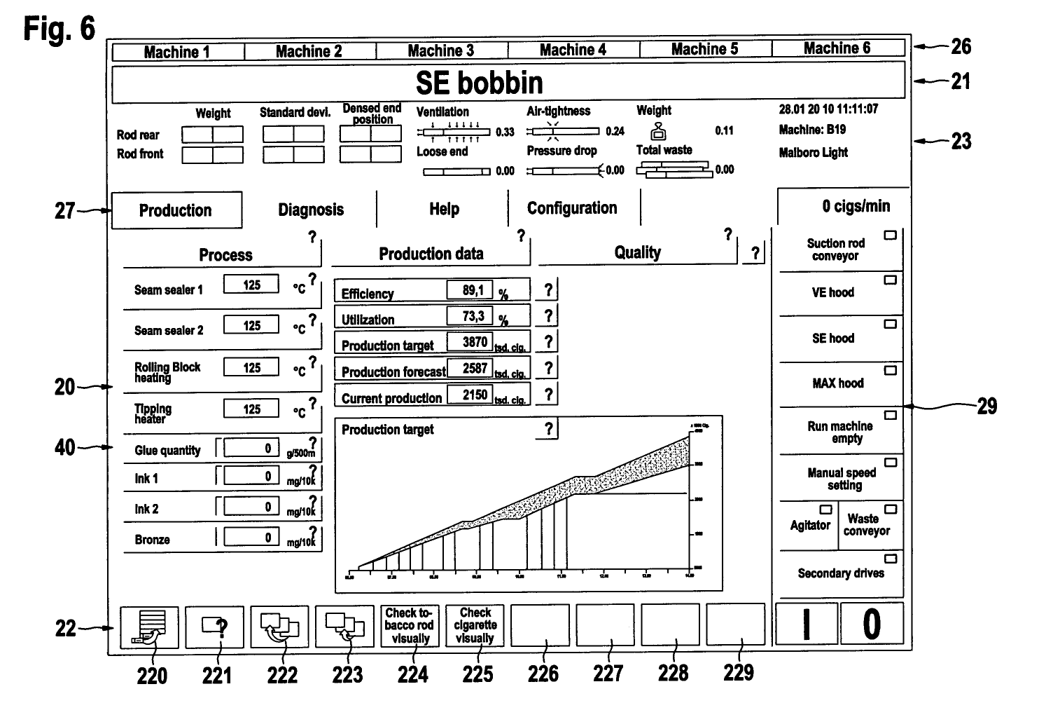

In the case of a display and operating unit known from EP 1 207 441 A1 for a cigarette production machine, the screen is divided into an upper message region for the display of warning, stop and information messages concerning the machine as well as general information such as date and time, shift number and cigarette brand (FIG. 4), and a lower operating region (FIGS. 5-7). The operator can choose between a graphic and a text-based display mode for the operating region. In the graphic display mode (FIG. 7) are displayed a plurality of images of the machine or parts of the machine that can be selected by the operator by means of navigation areas 41, 42. The images have icons for the display of functions of corresponding machine parts. On selection of an icon, an information window with machine- and product-related display elements and operating elements for the adjustment of machine- and product-related parameters is shown. Further, display elements 43 for display of the operating state of the machine are provided. Furthermore, operator assistance screen configurations (FIGS. 5, 6) are provided, which compared with the graphic display mode have differently arranged regions with different functions. This is unclear, whereby machine operation becomes more tedious and time-consuming; under certain circumstances there can even be operating errors.

From WO 00/16647 A1 is known a display and operating unit for a cigarette production machine using a graphic user interface. In a main screen display (main menu, FIG. 32) and other screen displays (FIGS. 33, 36) are provided a message region 420 individually configured in each case and an operating region with operating and navigation elements. In some screen displays (FIGS. 34, 35) there is no message region. This is unclear on account of the constantly changing display of the respective regions.

It is the object of the present invention to provide a display and operating unit and a display and operating method for a machine in the tobacco-processing industry, which allows efficient machine operation.

The invention achieves this object by the features of claim 1, in particular by the fact that essentially all screen displays that can be displayed during production have at least one further region which includes machine- and/or product-related display and/or operating elements concerning the production mode, whereby display of the further region is independent of the respectively selected operating-region display of the operating region. While the display and arrangement of display or operating elements change in the operating region, depending on the selected operating-region display, important ones of these display or operating elements are displayed in the further region according to the invention, independently of the respective operating-region display, and are therefore immediately available to the operator at any time. The operator does not therefore need to change to the respective operating-region display, in order to obtain a display of these display or operating elements. The constant availability of certain display or operating elements concerning the production mode of the machine also increases the user-friendliness and user-efficiency on account of the fact that the operator does not have to note in which operating-region display this information can be found.

In relation to the method claimed, the invention achieves this object by corresponding characteristics of claim 20.

The provision of the “further region” according to the invention means that, with a given screen size and given size of the message region, the operating region must be decreased in size accordingly. This basically runs counter to the aim of providing as large an operating region as possible in order to be able to simultaneously present as much information as possible in an operating-region display, and so keep the number of necessary changes between different operating-region displays as low as possible. In general, however, the number of necessary changes between different operating-region displays surprisingly decreases, on account of the “further region” according to the invention.

It is essential to the invention that “essentially all” screen displays generally occurring during production each have an operating region, a message region and a further region. These are essentially the screen displays that can be generated by means of the computer program to generate the graphic user interface for operation of the machine. These are in general machine- or product-related screen displays. However, it is sufficient for increasing the efficiency of operation during ordinary production, and hence for the success of the invention, if the screen displays “that can be displayed during ordinary production” comprise the aforementioned regions. Further, it is sufficient if this applies to “essentially” all screen displays, because use is still made of the invention even if the display of one single screen display, or a few, is different. Preferably, however, this applies to all screen displays that can be displayed during ordinary production without exception.

Operating elements are elements, for example in the form of input areas or buttons, which concern machine operation in the broadest sense, for example, allow the adjustment of machine parameters (nominal values) or the control of a machine part.

Machine- and/or product-related display elements concerning the production mode show machine and/or product-related information which changes in the course of production. The display of this information requires in the state of the art constantly bringing up a corresponding operating-region display. On account of the characteristic of “display or operating elements concerning the production mode”, the invention is delimited from the display known in the state of the art, of general information such as date and time, shift number and cigarette brand which is not machine- or product-related (date and time, shift number) or does not change in ongoing production (cigarette brand). Machine- or product-related elements are delimited from elements such as navigation elements concerning only the user interface itself.

Machines in the tobacco-processing industry include in particular cigarette production machines including filter cigarette production machines, filter production machines, cigarette storage systems, cigarette packing machines, material delivery devices for these machines and other devices associated with these machines.

A “screen display” denotes a particular graphic display shown on the screen. The term “screen mask” is also common for this. The screen displays form in combination a uniform graphic user interface. If a screen display has a selection area or an input area that can be actuated by the operator, the screen display includes every possible choice and every possible input by the operator. In other words, a screen display does not, for example, already become a different screen display as a result of the fact that the operator enters a given value in an input area and this value is displayed. Screen displays differ as a rule in the different layout or design of display or input elements such as areas, lists, graphic symbols and the like.

A “region” appropriately means a coherent or self-contained region. Separate regions which, for example, can be separated from each other by graphic dividing elements such as lines, by spacing apart or by different colours are advantageous for clarity. Preferably the arrangement of the regions or the division of the screen into different regions for the operator is predetermined invariably, so that a uniform manner of operation encompassing the operator is ensured. In particular, therefore, the individual regions are not shiftable on the screen. However, this is not necessarily the case. The regions can also be designed as windows in the case of a window-oriented user interface. The windows can then be shiftable for individual adaptation. The regions claimed are preferably displayed permanently.

A region that can be operated is one which has elements that can be actuated by the operator by means of an input device, for example, by touch screen. This also includes the input of characters in corresponding input areas, for example, by means of a keypad. For a region that cannot be operated, the display cannot be changed or influenced by actuation by means of an input device.

Stop messages are displayed as a result of a machine stopping. Warning messages are displayed as a result of an error, a fault, a deviation from the nominal state, or a material deficiency (paper, tobacco, ink, etc.), if machine stopping is not required. Appropriately, the messages are displayed in the message region by text, as graphic symbols can be misleading. In the message region can also be displayed information messages which, for example, relate to a given operating state.

The invention is particularly profitable in the case of a display and operating unit in which essentially all display and operating elements concerning the production mode are integrated in the graphic user interface. This concerns in particular the machine-related actions or adjustments which can be made when the machine is closed. “Essentially” means that in addition individual display or operating elements can be provided, for example, a separate “emergency off” element or an operator authorisation device. With a highly integrated display and operating unit of this kind, operation of the whole machine can take place during production via a single terminal. It is precisely with this application that, on account of the large number of display and operating elements that can be displayed, the problem of clear display which underlies the present invention arises.

In a preferred embodiment, the at least one further region includes a control region that can be operated by the operator with operating elements which can be operated for control of the machine. As a result, important control elements for control of the machine by the operator are available at any time and do not have to be searched for in the operating-region displays. Preferably the configuration of the control region, i.e. the arrangement and allocation of the control elements to the control functions depends only on whether the machine has stopped or is running, so that when the machine is running the configuration of the control region does not change.

Preferably, the at least one further region has a production measurement data display region with display elements for measured values which concern the current production, in particular the current product quality. These are in particular measured values which are measured by means of sensors in the machine on the product itself, or measured values which are obtained from a product waste analysis. As these measured values can change constantly, displaying them permanently is particularly useful for the operator and increases the efficiency of operation, as repeated changing to a corresponding operating-region display is dispensable.

Different operator groups with different privileges can be provided, whereby certain operating-region displays are accessible only to operators with higher privileges. Preferably, therefore, each operating-region display is assigned a priority which indicates which operators have access to the operating-region display on the basis of their privileges. Preferably, the allocation of priorities to the operating-region displays can be configured individually by the client.

Further advantageous characteristics and embodiments of the invention are apparent from the subsidiary claims and the following description of the invention with reference to the attached drawings. These show:

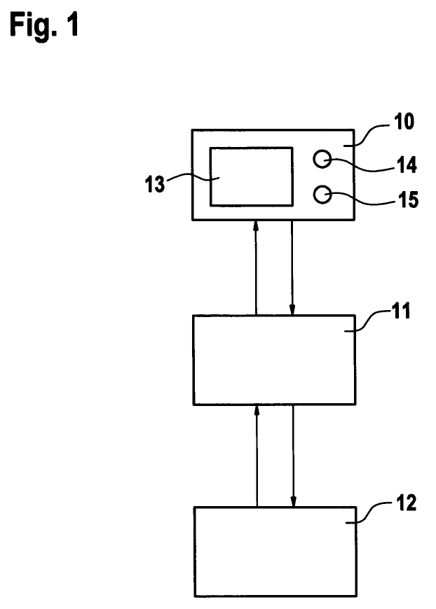

FIG. 1: a schematic view of an arrangement with a display and operating unit and a machine for producing a tobacco product;

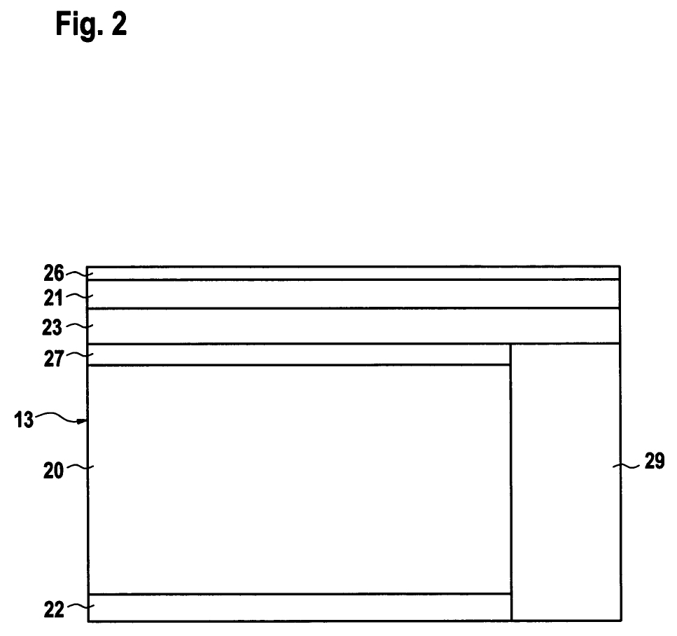

FIG. 2: a schematic view of a screen division;

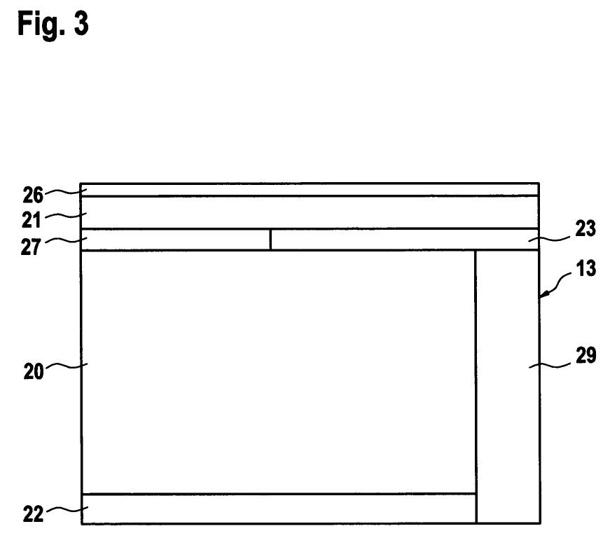

FIG. 3: a schematic view of an alternative screen division;

FIGS. 4-7: a first screen display of the graphic user interface;

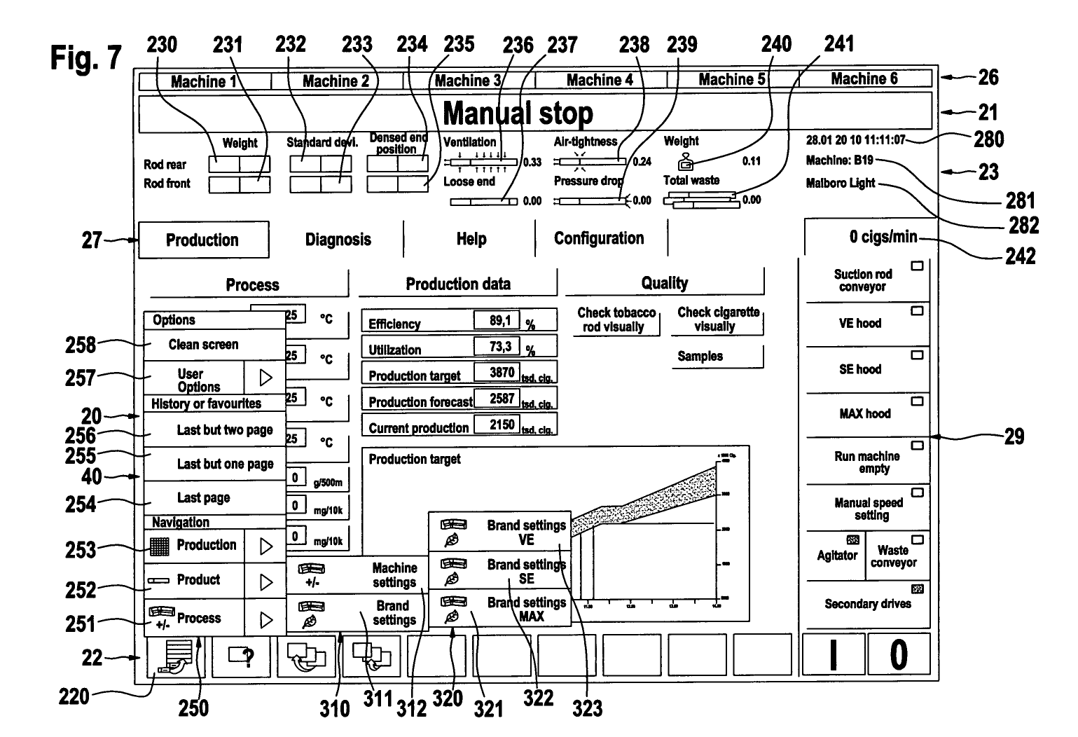

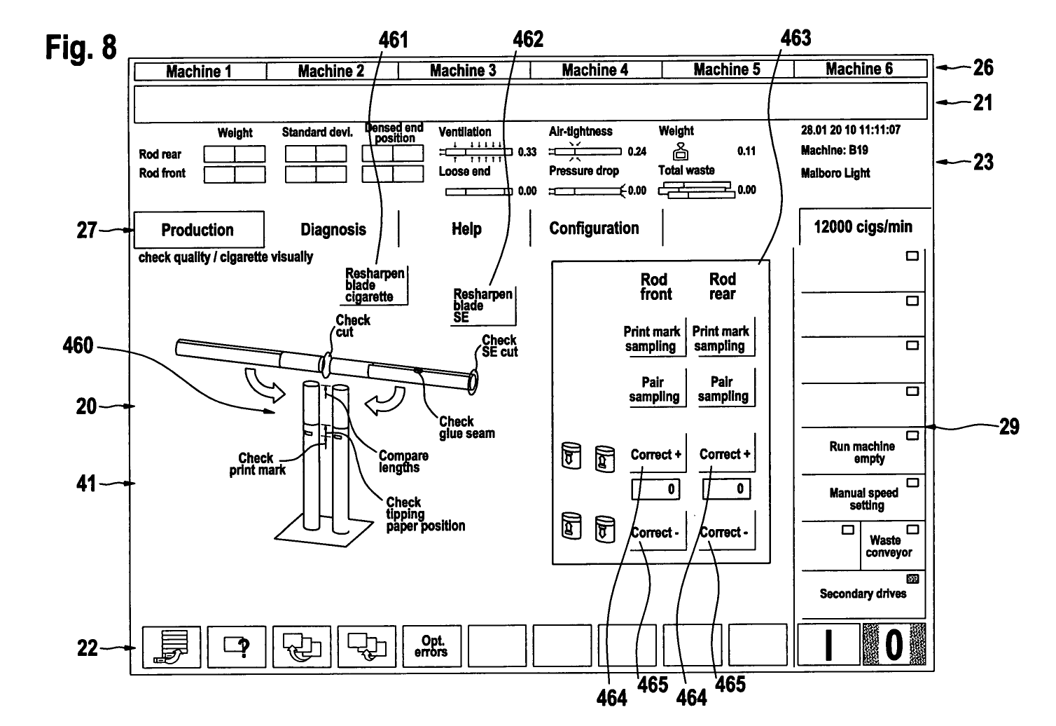

FIGS. 8-10: a second screen display of the graphic user interface;

FIGS. 11, 12, 14: a third screen display of the graphic user interface;

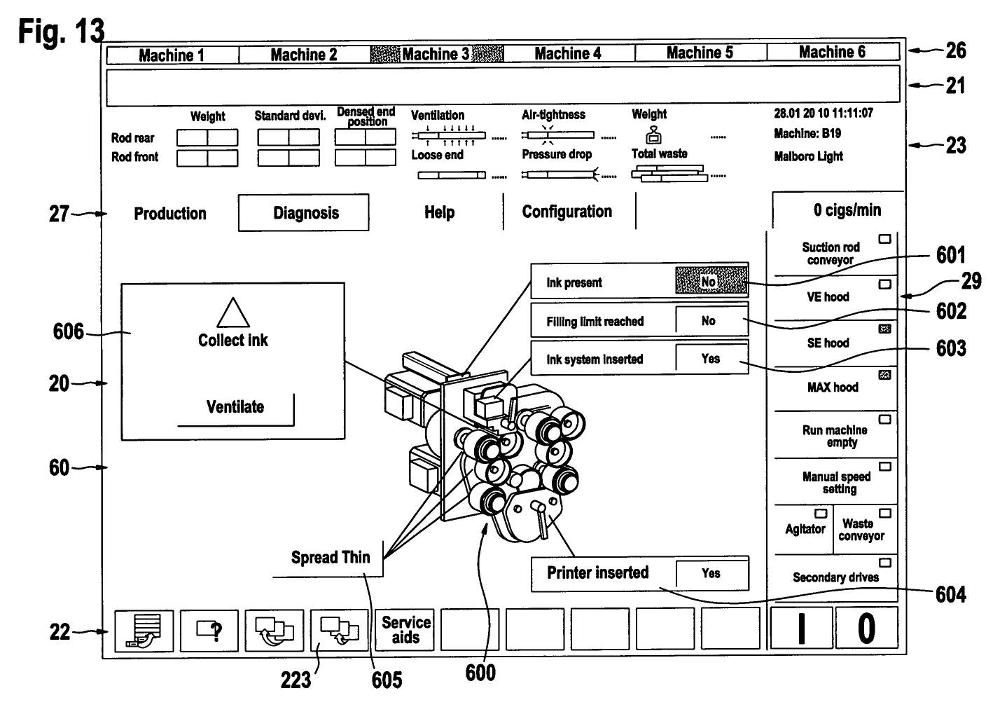

FIG. 13: a fourth screen display of the graphic user interface;

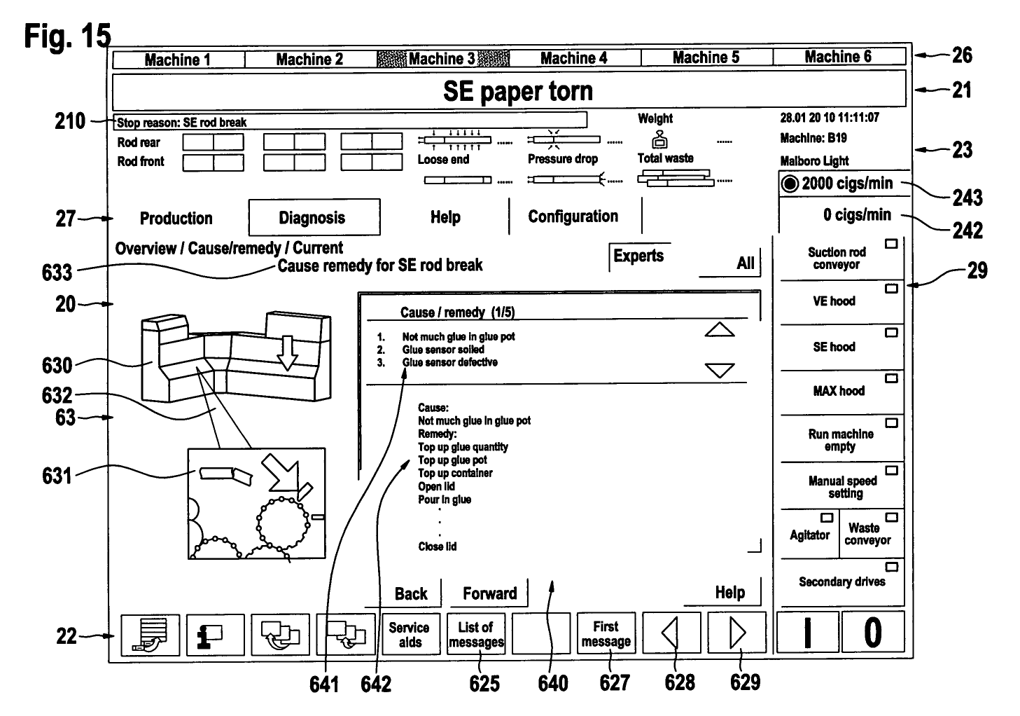

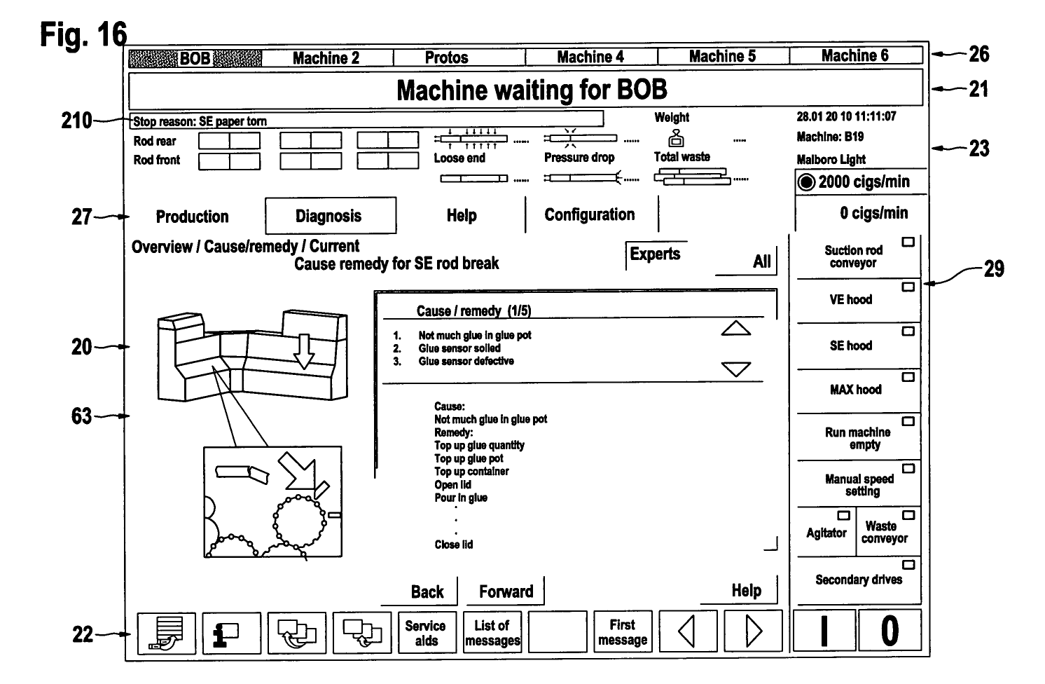

FIGS. 15, 16: a fifth screen display of the graphic user interface;

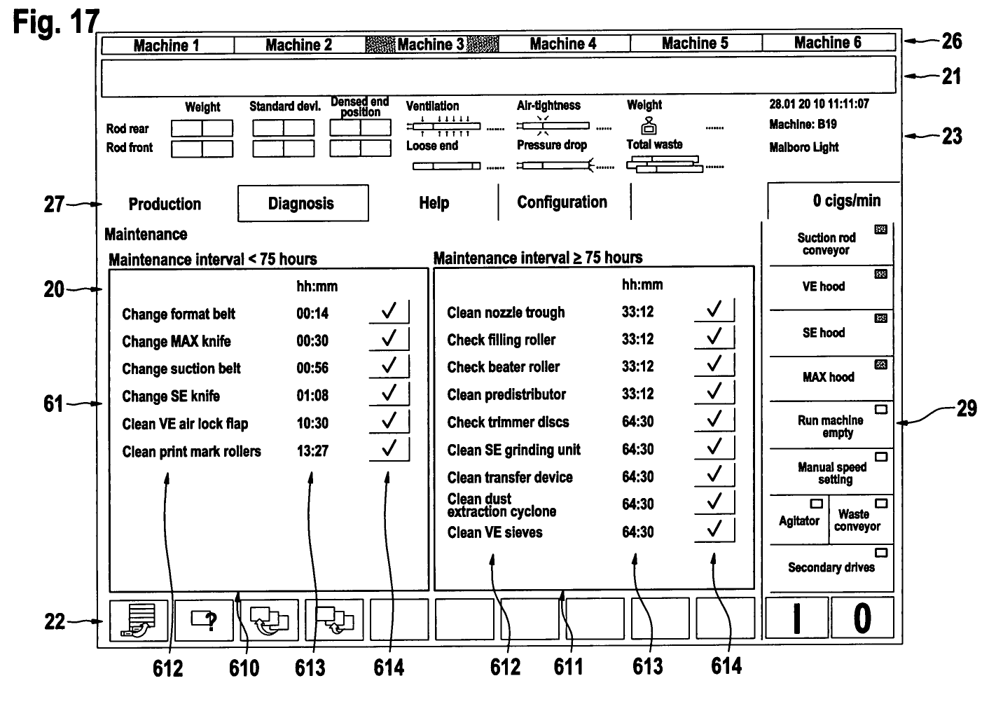

FIGS. 17-23: sixth to eleventh screen displays of the graphic user interface.

The display and operating unit for a machine 12 for producing a tobacco product includes the visual display unit 10 and the computer 11. The visual display unit 10 includes a touch-sensitive screen (touch screen) with a display region 13 and an emergency off actuator 14 and an operator authorisation device 15. The screen size is preferably in the region of more than 12 inches. In the display and operating unit 10, 11 are integrated essentially all display and operating functions of the machine 12 which are available during ordinary production when the machine is closed.

FIG. 2 shows a screen division of the display region 13 for essentially all screen displays that can be displayed during production. The display from FIG. 2 preferably corresponds to the total active area of the screen; however, it may also be a window or a plurality of windows. The screen is divided into a plurality of rectangular regions. In the lower part of the screen is provided the operating region 20 for the display of one out of a plurality of different operating-region displays. In the upper third of the screen, that is, in the region to which the operator pays most attention, is provided the message region 21 for the display of machine- or product-related stop and warning messages.

The “further region” in the sense of the claims includes the control region 29 for control of the machine 12 and the production measurement data display region 23 for the display of measured values concerning the current production mode, and in particular characterizing the quality of the product currently being processed. The production measurement data display region 23 is preferably also arranged in the upper third of the screen, for example, under the message region.

The operating region 20 is assigned a group selection region 27 for the selection of groups of operating-region displays, as well as a navigation region 22 for navigation between different operating-region displays and selection of certain operating-region displays by the operator. At the upper edge of the screen can be provided a line display region 26 which in case of a line of several machines has one area for each machine.

FIG. 3 shows an alternative division of the screen into the different regions. This design can be used, for example, with smaller screens, for example, 12-inch screens. The screen displays shown in the other figures relate to the screen division shown in FIG. 2.

For clarity, and in order to be able to display sufficient number of display and operating elements, it is advantageous if the further region or the control region 29 and the production measurement data display region 23 have sufficient size. The area of the further region 29, 23 is therefore, compared with the area of the operating-region 20, preferably at least 10%, more preferably at least 20%, more preferably at least 30%; the corresponding area ratio for the control region 29 is preferably at least 10%, more preferably at least 15%, more preferably at least 20%. For the production measurement data display region 23, the corresponding area ratio is preferably at least 5%, more preferably at least 10%, more preferably at least 15%. Referred to the total screen display area 13, the area of the further region 29, 23 is preferably at least 5%, more preferably at least 10%, more preferably at least 15%. The corresponding area ratio for the control region 29 is preferably at least 4%, more preferably at least 7%, more preferably at least 10%. The corresponding area ratio for the production measurement data display region 23 is preferably at least 3%, more preferably at least 6%, more preferably at least 8%. The area of the operation region 20 is, compared with the total screen display area 13, preferably at least 25%, more preferably at least 35%, more preferably at least 45%.

In FIGS. 4 to 23 are shown various screen displays which differ essentially with respect to the operating-region display selected at any given time. In other respects, the various screen displays are constructed or configured largely identically.

The line display region 26 has corresponding areas 260, 261, 262, . . . for the machines in the line that can be operated by the operator—in particular by means of corresponding operating units (bobbin loaders, filter makers, cigarette production machine, packing machine, etc.). The area of the machine to which is assigned the respective display and operating unit may be highlighted. Each machine in a line can be assigned its own display and operating unit. The areas 260, 261, 262, . . . can in particular serve to display in what state the respective machine is, for example, running, stopped or on standby. This can be done by colour coding, for example.

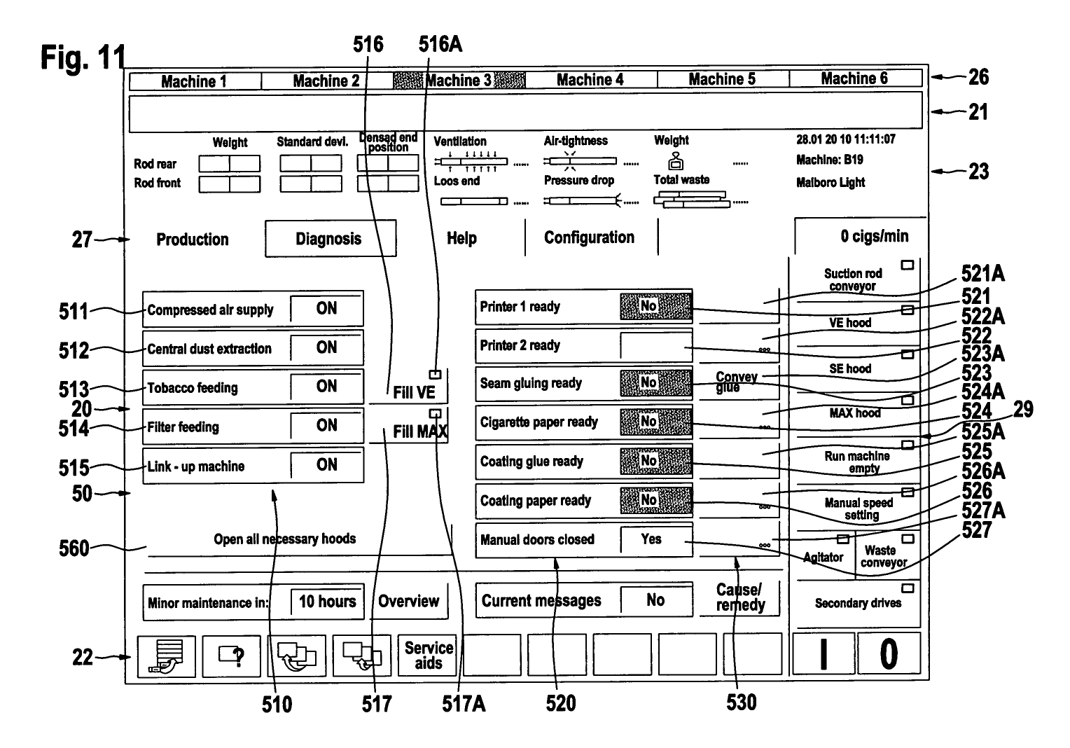

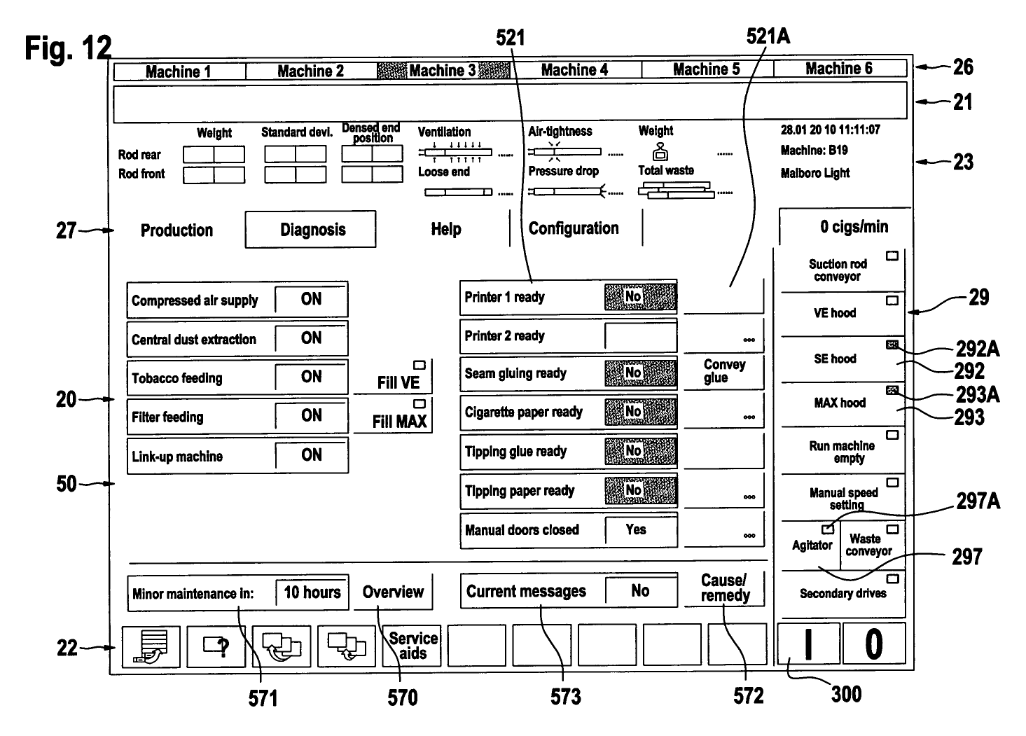

In the message region 21 are displayed messages in the form of line text. These are in particular stop messages when a machine stops, for example, “manual stop”, “SE paper torn”. This message is in general displayed as long as restarting of the machine cannot take place because of the original reason for stopping. In the message region 21 are also displayed warning messages, for example, “SE bobbin” (see FIG. 6) on account of a bobbin change required in the near future. In the message region can also be displayed information messages, for example, “machine waiting for BOB” (see FIG. 12) when the machine is waiting for a corresponding link-up machine to be ready for operation.

The message region 21 can be assigned a first message region 210 (see FIGS. 15, 16) in which, when a machine stops, the first message corresponding to the original reason for stopping is displayed until restarting of the machine takes place. In the message region 21 can be displayed follow-up messages to the first message. The first message region 210 can display, for example, by colour coding, whether the cause of stopping on which the first message is based has been eliminated or not. The first message region 210 is displayed temporarily when a follow-up message is displayed. It may overlap other regions, for example, the production measurement data display region 23.

In the production measurement data display region 23 are provided display elements 230, 231, 232, . . . , 241 which display measurement data which characterise product quality. The data of the display elements 230 to 235 were measured by means of corresponding measuring devices in the machine 12 on the product itself currently being processed. The data of the display elements 236 to 241 were measured on waste of the product currently being processed. They indicate the relative frequency of waste of the product for different waste criteria. Also, in the production measurement data display region 23 are provided display elements 242, 243 for other production-related measurement data, for example, the number of cigarettes currently being processed per minute. Production measurement data can be measured constantly online or upon operator inquiry, i.e. as a result of the actuation of corresponding operating elements in particular in a corresponding operating-region display. Preferably, the production measurement data display region 23 basically can be configured with respect to the selection or arrangement of display elements 230, 231, 232, . . . , 241 to allow, for example, adaptation to individual customer requirements. On the other hand, the production measurement data display region 23 is not variable during ordinary production, because the operator should be able to rely on the constant availability of the same display elements 230, 231, 232, . . . , 241.

In the production measurement data display region 23, or in another region, can be provided display elements 280, 281, 282 for the display of general, not directly production-related information such as date and time, machine type or cigarette brand.

The control region 29 consists of control elements 290, 291, 292, . . . , 300 which are permanently assigned to certain machine control functions respectively. The respective machine control functions are here caused as a result of actuation of the button 294 directly, or after a confirmation inquiry, but not via the diversion of a corresponding operating-region display. The control elements are therefore not navigation buttons for the operating region 20. Preferably in particular manual stopping of the machine (control element 299), starting of the machine (control element 300), manual setting of the machine speed (control element 295), empty running of the machine (control element 294), switching on/off the waste conveyor for product waste (control element 296) and/or switching on/off the secondary drives (control element 298) are provided. By actuation of the control element 299, controlled stopping of the machine is triggered, by contrast with emergency switching off which stops the machine immediately under all circumstances, regardless of possible damage. Actuation of the button 294 causes automatic empty running of the machine from the current production mode, i.e. exit of all material, for example, for a change of brand. Here in particular the tobacco supply to the feeder is switched off. The actuation of a button of the control region 29 can lead to a change of operating-region display; this is, however, not absolutely necessary.

When the machine is at a standstill, preferably a button 290 is provided for switching the suction rod conveyor on and off and/or a button 297 for switching the tipping glue agitator on and off. Buttons 291 to 293 may also be provided for opening hoods of the feeder VE, the rod maker SE and the filter assembler MAX; this is, however, not absolutely necessary.

Both while the machine is running and when it is at a standstill, preferably a button 295 is provided for adjusting the machine speed. By actuating the “Manual speed setting” button 295, the display area 243 for the nominal machine speed and an actuating element, not shown, are activated automatically (see FIG. 15). The actual machine speed is displayed at all times in the display area 242. Operation of the button 295 depends on whether the machine is at a standstill or running. When the machine is at a standstill (see FIG. 15), actuation of the actuating element, not shown, first leads only to a shifting of the nominal value displayed in the display area 243. Only after running up of the machine as a result of actuation of the start button 300, does the machine speed change to the set nominal value. When the machine is running, rotation of the actuating element, not shown, leads to an immediate increase or lowering of the machine speed, whereby the current machine speed at any given time is displayed in the area 242. By reactuation of the button 295, the mode described can be left again and the display area 243 deactivated.

The control elements 290 to 300 can be assigned status indicators 290A to 300A which indicate the (operating) status of respectively associated machine parts or actions, for example, hood open (control elements 291 to 293), machine part in operation (control elements 290, 296 to 298), action is being performed (control elements 294, 295). This is shown in the figures by means of status indicators filled in in black. For instance, during ordinary production the status indicator 298A indicates that the secondary drives are in operation (FIG. 4).

The configuration of the control region 29 depends on whether the machine is at a standstill or running. When the machine is at a standstill, the buttons 290-293, 297 can be actuated; when the machine is running, these buttons are inoperative (FIGS. 8-10) or instead are not displayed. The buttons that can be actuated when the machine is at a standstill concern in particular functions which would be inappropriate while the machine is running, for example, for safety reasons, for example, opening machine covers (buttons 291-293).

In the operating region 20 are displayed different operating-region displays 40, 41, 50, 60, 61, 62, . . . An operating-region display is here an image that fills out the whole operating region. In FIGS. 4 to 22 are shown only some of all the operating-region displays of a machine that can be displayed. The total number of all operating-region displays that can be displayed during production is as a rule at least 30, preferably at least 60, more preferably at least 100.

All the operating-region displays that can be displayed are divided into (main) groups which can be selected by the operator by means of a permanently displayed group selection region 27. For this purpose, group selection buttons 271, 272, 273, 274 are provided in the group selection region 27. The group button of the main group selected at any given time is graphically highlighted (shown in the figures by framing the respective group selection button). Each operating-region display is permanently assigned to one or a plurality of groups. The operating-region displays are hierarchically structured within a group, a main operating-region display (40; 50; 65; 66) standing at the top of the hierarchy of each group. Preferably, for each group a screen display can be stored as current, so that on changing from one group to another group the current screen display of the other group is displayed. This facilitates operation, as the screen displays that are current at any given time do not have to be laboriously searched for. If, for example, a screen display is displayed in the group of Diagnosis to remedy a given fault, and the operator changes to the Help group in order to let a corresponding help subject be displayed, then after a return to the diagnosis group the previously displayed screen display for the given fault is displayed again.

For navigation between the different operating-region displays, a permanently displayed navigation region 22 is provided below the operating region 20, for example. In the navigation region 22 are provided navigation buttons 220, 222, 223 displayed permanently and independently of the respective operating-region display. The button 223 scrolls back to the operating-region display displayed immediately before the current operating-region display, which if necessary can be connected with a change of main group. The button 222 brings up the main operating-region display of the respective main group. Scroll-back functions other than those described are possible too.

The button 220 leads to display of a fly-out menu 250 with items 251, . . . , 258 (see FIG. 7). The items 251-253 allow the selection of certain operating-region displays, in the example of FIG. 7 “Brand settings VE”, “Brand settings SE” and “Brand settings MAX”. This can take place by means of submenus 310, 320. In the example of FIG. 7, by actuation of the “Process” item 251 in the menu 250 the submenu 310 with two items 311, 312 is brought up. By actuation of the “Brand settings” entry 311 in the menu 310, the sub-menu 320 with three items 321, 322, 323 is brought up. Actuation of one of the items 321, 322, 323 then causes display of the corresponding operating-region display in the operating region 20. It may be provided that when the menu 250 is brought up the submenus leading to the currently displayed operating-region display are also displayed automatically.

The items 254 to 256 of the menu 250 allow the selection of previously displayed operating-region displays. An operator-dependent configuration of items of the menu 250 may also be provided, i.e. occupancy by, for example, operating-region displays individually preferred by the operator (favourites). Display of the menu 250 is deactivated again after selection of an operating-region display.

In the navigation region 22 are also provided navigation buttons 224, 225, . . . , 229, the activation and number of which are dependent on the operating-region display selected at the time. These buttons may also be included in the respective operating-region display itself.

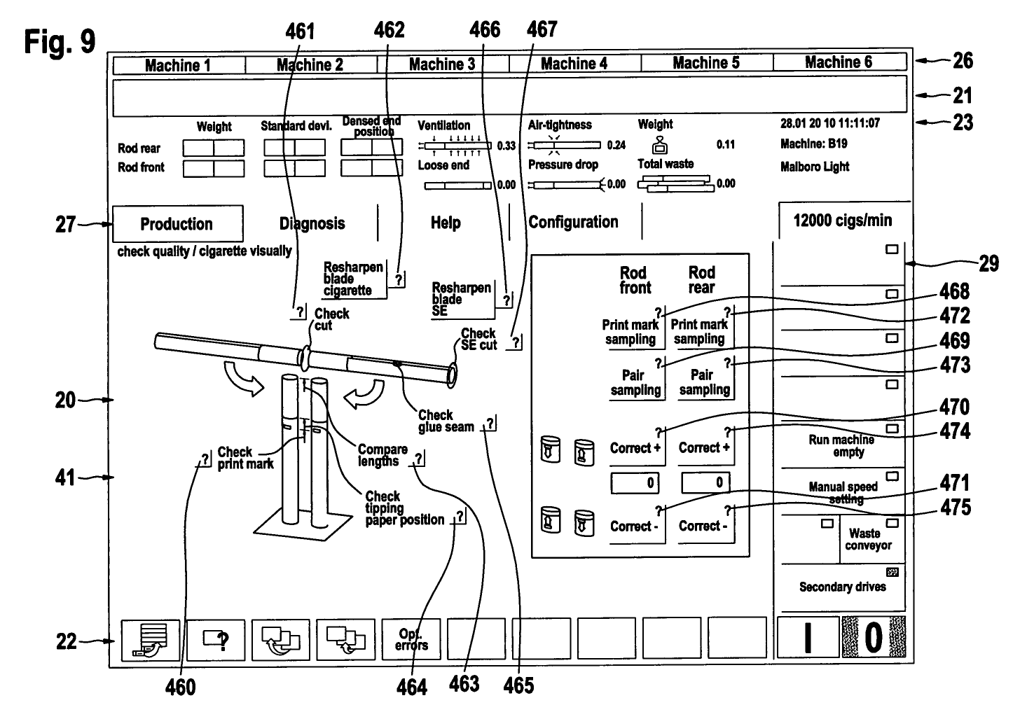

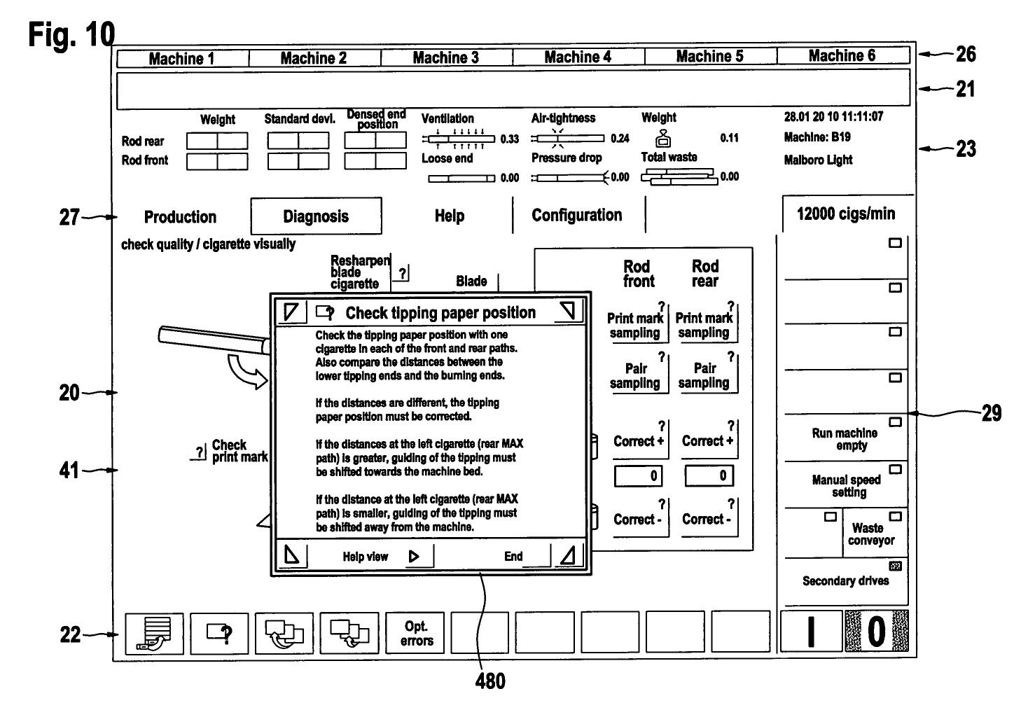

The selection area 221 serves to display context help selection areas 460, 461, . . . , 470, . . . (see FIG. 9) which in the present case are each marked with a question mark and assigned to a display or operating element or part of one. The actuation of a context help selection area 460, 461, . . . leads to the display of a corresponding context help window 480 with an explanation on the respective part for the operator. In the embodiment, actuation of the context help selection area 464 in FIG. 9 leads to display of the context help window 480 in FIG. 10. Context-sensitive help can basically be available in all operating-region displays (cf. the context help selection areas marked with question marks in FIG. 6).

The “Production” main group that can be selected by means of the group selection button 271 is the main group preferably selected during ordinary operation, as it prepares the display and operating elements relevant to production for display. The overview 40, i.e. the topmost operating-region display hierarchically, of the “Production” group includes production-, machine- and/or product-related display or operating elements as well as, if necessary, navigation buttons. Display elements serve in general to display production-, machine- and/or product-related information. Operating elements which concern the production mode are those whose actuation allows the production mode to be influenced.

The main operating-region display 40 includes display and operating elements 410, 411, 412, . . . , 417 for production-related machine adjustments, display elements 430, 431, . . . , 435 for current production data, and/or selection buttons 450, 451, 452 for product-related operating-region displays. Accordingly, the main operating-region display 40 is divided into three subregions 400 “Process”, 420 “Production data” and 440 “Quality”.

The display and operating elements 410, 411, 412, . . . , 417 concern the display of current values of given production-related machine parameters, and also preferably the display of corresponding nominal values. The nominal values can be altered by the operator by entry in corresponding input areas. For this purpose a keypad area 300 may be brought up temporarily, for example by touching one of the display and operating elements 410, 411, 412, . . . , 417. The keypad area 330 includes a display area 331 for the name of the machine parameter, display elements 332 for minimum and maximum values of the machine parameter, a display area 333 for the currently entered value, and a numerical keypad 334 for entry of the value. In the example of FIG. 5, the nominal value of the machine parameter “Temperature of seam sealer 1” can be altered by the operator by means of the touch keypad 334 in the keypad area 330. Other possible entries are conceivable.

The display elements 430, 431, . . . , 434 serve to display quantities and times relating to ongoing production. The display element 435 serves for graphic display of the production quantity over time.

Actuation of the selection buttons 450, 451, 452 leads to corresponding product-related operating-region displays essentially for monitoring the current product quality. These are therefore operating-region-related navigation buttons 450, 451, 452. The navigation buttons 450, 451, 452 can instead be arranged in the navigation region 22. This is the case, for example in FIG. 6, where display of the navigation buttons 450, 451, 452 in the subregion 440 “Quality” is impaired by context help display elements.

Actuation of the selection area 452 in the operating-region display 40 leads to display of the corresponding operating-region display 41 shown in FIGS. 8 to 10. Different check criteria (“Check print mark”, “Check cut”, etc.) are displayed in this with the aid of images 460 of the product, and can be selected by the operator. Further, control buttons 461, 462 are provided for resharpening corresponding blades. In a corresponding display and control region 463, the parameters on which the check criteria are based can be changed. In FIGS. 8, 9, for example, the print mark position relative to the filter can be changed by actuating the buttons 464 “Correct +” and 465 “Correct −”.

The “Diagnosis” main group which is selected by means of the group selection button 272 concerns essentially operating-region displays in connection with the machine at a standstill, in particular faults, preparation of the production mode or producing readiness for operation and/or machine maintenance.

The overview 50 of the “Diagnosis” main group serves to show display elements which concern the status or supply to given machine parts. These can be in particular the display elements of machine functions which must be ready for operation before the machine can be switched on. In the example of FIG. 11, the display elements 511 to 515 shown in the subregion 510 indicate that corresponding supply devices or the link-up machine are switched on or ready for operation. The display elements 521 to 527 shown in the sub-region 520 indicate in the example of FIG. 11 that the corresponding machine parts are essentially not ready for operation. In respectively associated display and operating areas 521A to 527A it can be indicated that given operator actions are necessary (see, for example, display and operating area 523A). If all the machine functions assigned to the display elements 511 to 515, 521 to 527 are ready for operation, the button 300 for starting the machine is shown in green.

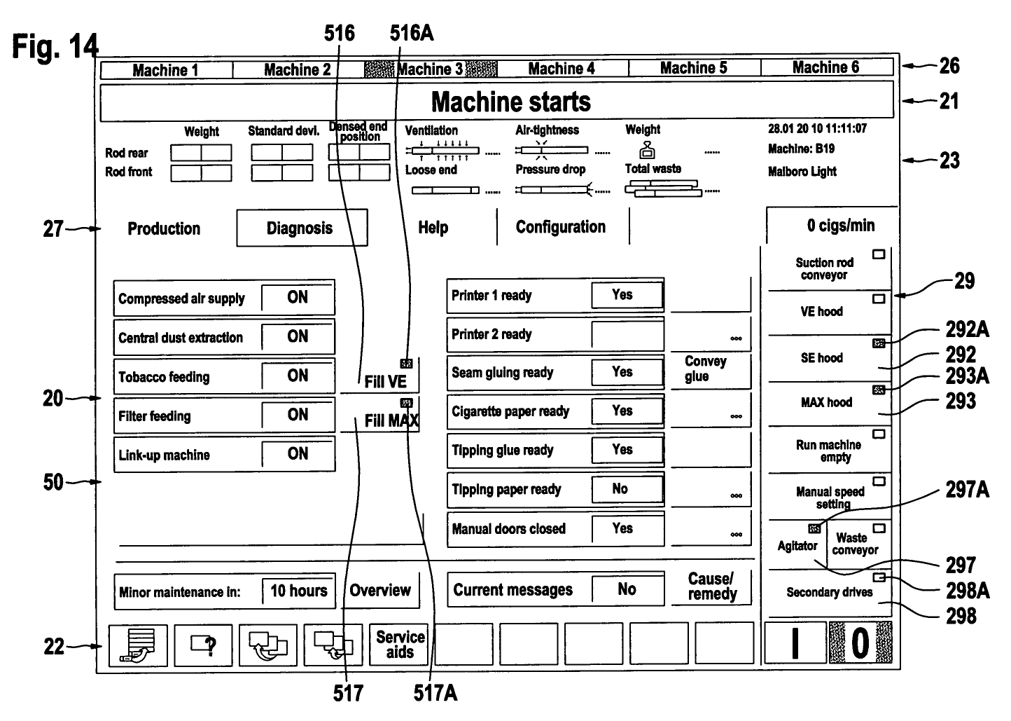

After switching on the machine, for example, by means of a main switch, it may be provided that the overview 50 is displayed automatically. By actuation of the button 560, the necessary hoods are opened, in the present case the hoods of the rod maker SE and the filter assembler MAX. The open status of these hoods is shown in FIG. 12 by marking of the status indicators 292A, 293A for the control elements 292, 293 for opening these hoods. As the printer is not ready, the associated display and operating area 521A can be actuated by the operator in order thus to bring up the operating-region display 60 (FIG. 13). Generally, for the display elements 521 to 527, corresponding operating-region displays which indicate the actions to be performed to produce the missing readiness of a part of the machine, in particular by showing the corresponding part of the machine, can be brought up by means of the buttons 521A to 527A. In the example of FIG. 13 this is an image 600 of the printer with display elements 601 to 606 which indicate the status of parts of the printer, and directions if necessary. In the present case the display element 601 indicates that there is a lack of ink. After refilling with ink by the operator there is a return to the operating-region display 50 shown in FIG. 11, for example by actuation of the navigation button 223 in FIG. 13, in which case however the display element 521 indicates by “Yes” that the printer is now ready for operation. Subsequently, the display elements 523, 524, 525, 526 can be worked through by the operator. For instance, the tipping glue can be made ready for operation by switching on the tipping glue agitator by means of the button 297 (display 525 changes to “Yes”; display 297A indicates that the agitator is switched on, see FIG. 14). After the machine has been made ready, i.e. the conditions necessary for starting the machine are fulfilled, the colour of the control element 300 for starting the machine changes to green. After actuation of the control element 300 by the operator, the operating-region display 50 shown in FIG. 14 is displayed. The hoods of the rod maker SE and filter assembler MAX are closed automatically, which leads to the corresponding displays 292A, 293A going out. The feeder VE and the filter assembler MAX are automatically filled, which is indicated by the corresponding status indicators 516A, 517A (see FIG. 14). The buttons 516, 517 for manual filling of the feeder and filter assembler which are assigned to the corresponding display elements 513, 514 therefore do not have to be actuated by the operator. The secondary drives are switched on automatically without the button 298 having to be actuated. The status indicator 298A indicates that the secondary drives are switched on. Directions for starting the machine are displayed in the message region 21.

After actuation of the button 300 for starting the machine, it is checked whether external units, for example, other machines from the line, are ready for operation. If an external unit required for the production mode of the machine is not ready for operation, the machine is not started, but remains in an inoperative state (standby) until the external unit is ready for operation. In the example of FIG. 16 the machine is in such a waiting state. When all external units have been made ready for operation, automatic starting of the machine can then take place.

The “Diagnosis” main group that can be brought up by the button 272 further includes an operating-region display 61 for display and operating elements in connection with machine maintenance (see FIG. 17). These can be brought up, for example, by actuation of the button 570 in the main operating-region display 50 (see FIG. 12). This can further have a display element 571 for display of the period of time until the next maintenance action is due (in the example of FIG. 17 “14 min” would be displayed in the display element 571). The display element 571 can also be actuated for the display of an operating-region display concerning regular maintenance. In a subregion 610 of the operating-region display 61 are displayed display elements which within a given interval of time (here 75 hours) display maintenance actions are to be performed. In a sub-region 611, display elements are displayed for maintenance actions to be performed beyond this interval of time. The display includes short titles 612 of actions to be performed, the length of time 613 until the respective action is due, and an indication 614 of whether a given action has already become due. In the example of FIG. 17 no maintenance action is currently due.

The “Diagnosis” main group that can be brought up by the button 272 further includes fault operating-region displays for display and operating elements in connection with faults of the machine, or as a result of stop or warning messages, in particular when a machine has stopped. When a fault occurs, it may be provided that a fault operating-region display for a corresponding fault message is displayed automatically. This fault operating-region display can also be brought up manually, for example, via the button 572 in the overview 50 (see FIG. 12). A display element 573 which indicates whether there are current messages may also be provided there.

For every message which occurs as a result of a fault, a separate fault operating-region display of the kind shown in FIGS. 15, 16 is provided. In the example of FIGS. 15, 16 this is the operating-region display for the fault message “SE rod break” which indicates a rod break in the rod maker SE. The respective fault message is displayed in the display element 633.

The fault operating-region display 63 includes an overview 630 of the whole machine and a schematic display 631 of the machine part affected by the fault, which is assigned by means of an arrow 632 to the overview 630 according to its arrangement in the machine. In a subregion 640, in an upper region is included a list 641 of all possible causes of the corresponding fault message, preferably in order of statistical frequency of the causes occurring in connection with the respective fault message. In the list 641 each cause can be selected by the operator. For a selected cause, in a lower region of the sub-region 640 are displayed the actions required to remedy the cause in the form of a list 642.

All fault messages occurring as a result of the machine stopping are compiled in the form of a message list which can be displayed in an operating-region display, not shown; the latter can be brought up by actuating a navigation button 625 in the fault operating-region displays. For every fault operating-region display, fault operating-region displays for the previous and the next message in the message list can be brought up by means of the navigation buttons 628, 629. Further, the fault operating-region display of the first message for the respective fault can be brought up by means of the navigation button 627.

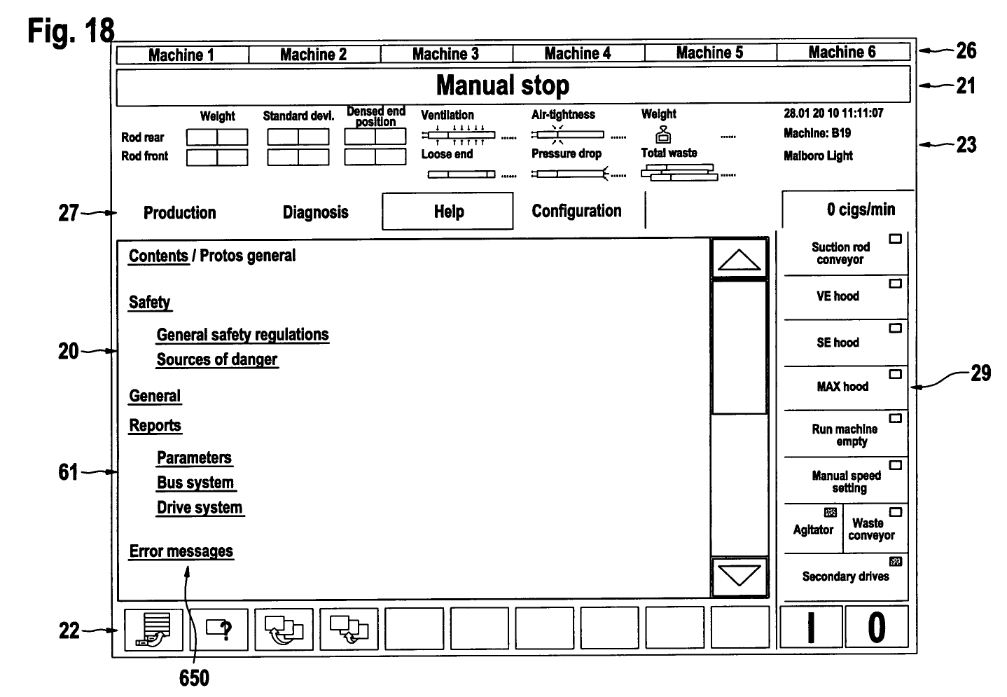

The “Help” main group that can be brought up by the button 273 includes the overview operating-region display 65 (see FIG. 18) which shows a list of contents with display and operating elements 650 which are assigned to corresponding help operating-region displays. A help operating-region display can be brought up, for example, by touching the respective display element 650. The help operating-region displays are used for display in order of subject of an operator's manual in particular for the machine, where one help operating-region display includes a part of the operator's manual on one subject.

The “Configuration” main group that can be brought up by the button 274 includes the overview operating-region display 66 (FIG. 19) which allows access to further operating-region displays by means of navigation buttons 660 to 663. Operating-region displays concerning machine maintenance (see FIG. 17, for example) may be provided (navigation button 660). The operating-region displays concerning machine maintenance may also be brought up via the “Diagnosis” main group (see, for example, button 570 in FIG. 12). Also operating-region displays concerning shift management, in which for example shift times may be configured, may be provided (navigation button 661).

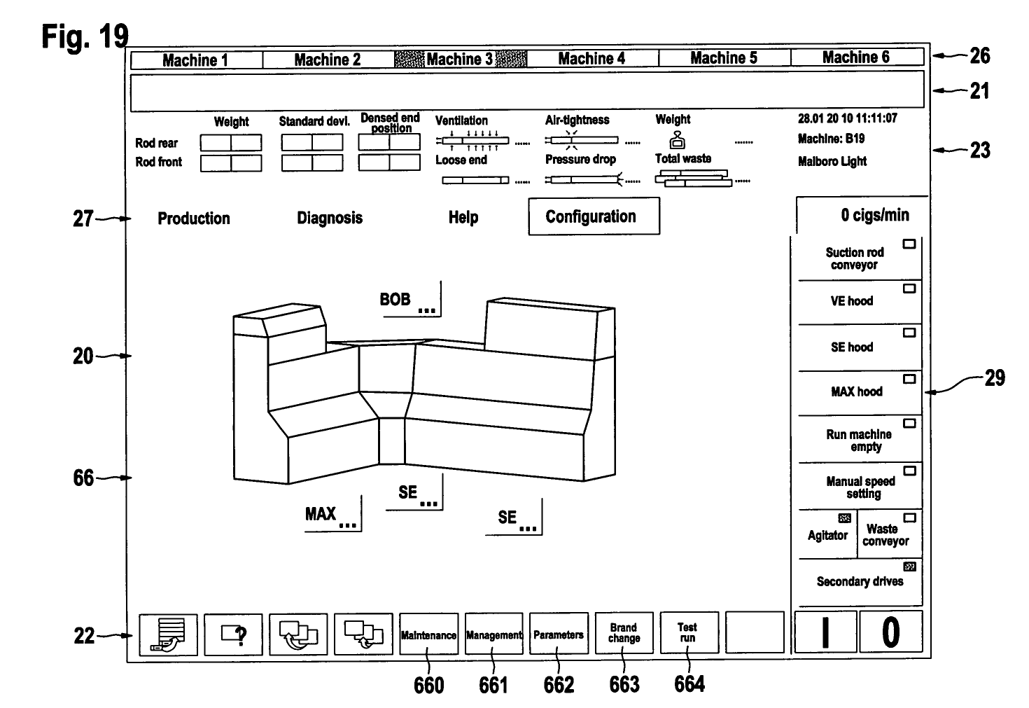

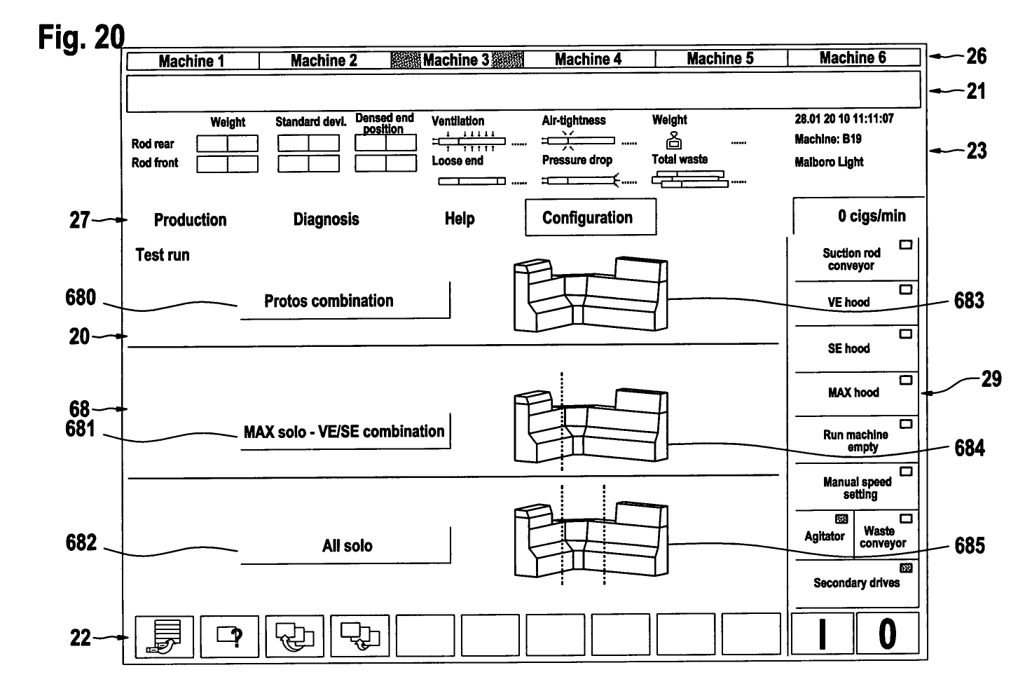

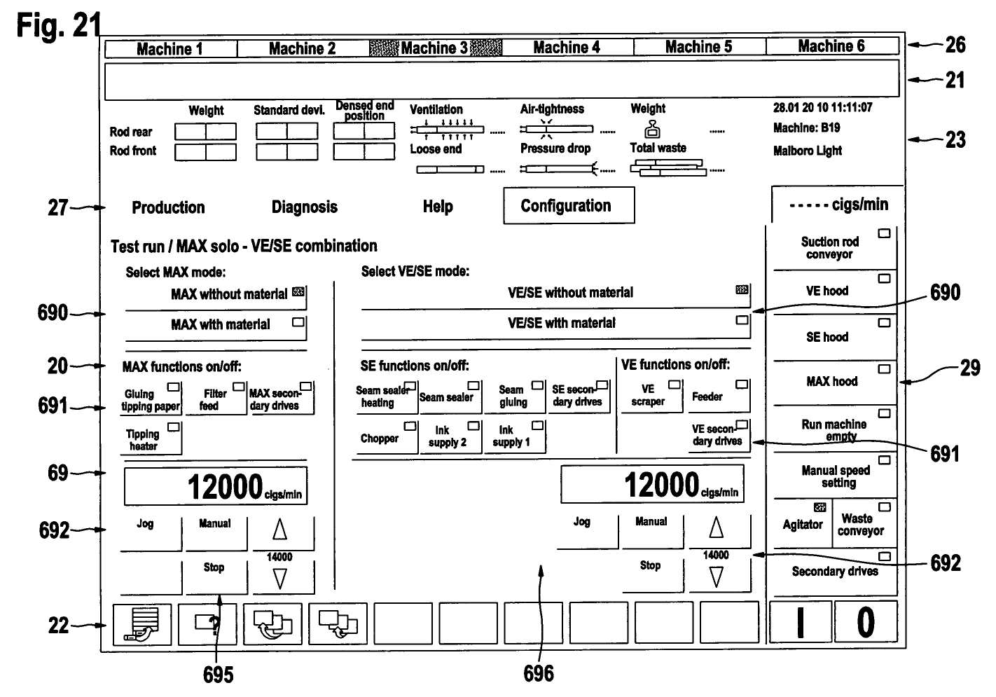

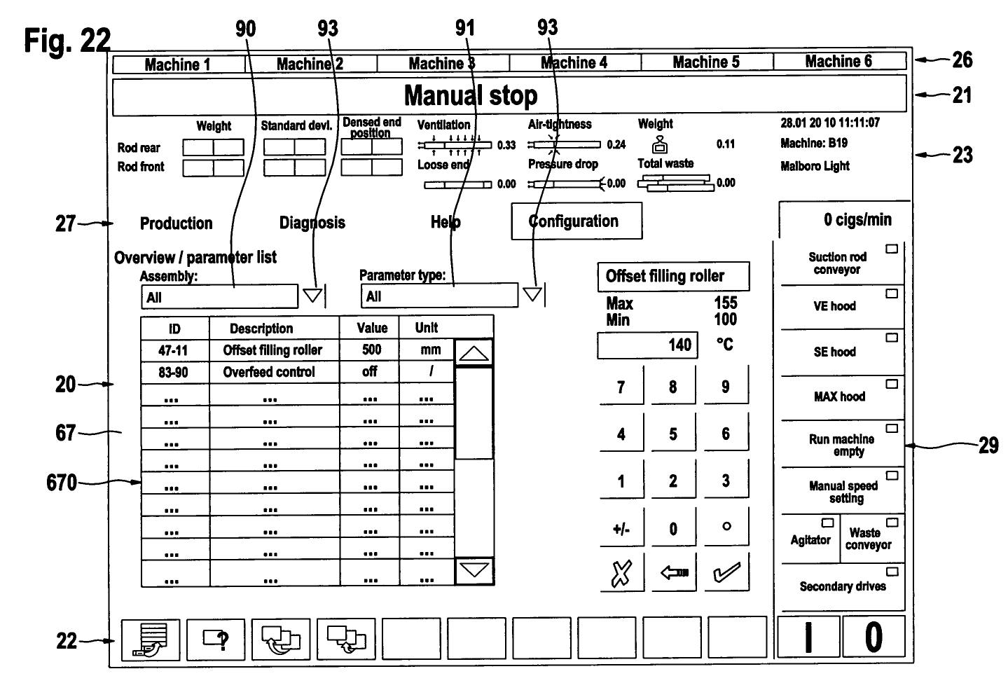

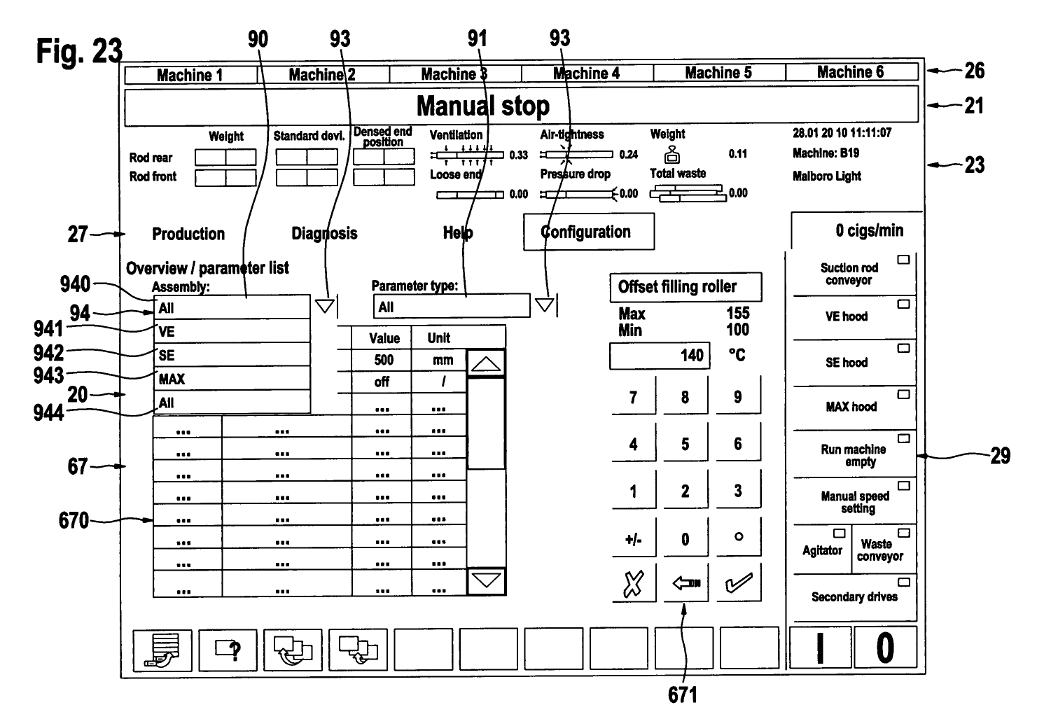

Preferably, an operating-region display 67 which allows adjustment of the nominal values of all adjustable machine parameters is provided (FIGS. 22, 23). This can be brought up, for example, by actuating the navigation button 662 in the operating-region display 66. The operating-region display 67 contains a list of contents 670 of all adjustable machine parameters. From the list 670 parameters can be selected, for example, by touching. Selected parameters can be changed by means of a keypad area 671 which is constructed similarly to the keypad area 330.

In the operating-region display 67 are provided target selection areas 90 and 91 for the selection of parameter targets by the operator, by means of which the parameters displayed in the list of contents 670 can be limited to given parameters associated with the selected parameter targets. Each of the target selection areas 90, 91 has a button 93 whose actuation leads to the display of a respectively associated target selection list 94 (in FIG. 23 only the target selection list 94 associated with the target selection area 90 is shown). The (or each) target selection list 94 includes (in each case) a plurality of list areas 940, 941, 942, . . . . For example, by touching a list area 940, 941, 942, . . . a parameter target displayed in this list area is transferred to a respective target selection area 940 of the target selection list 94, and thus selected.

The target selection list 94 concerns different machine regions and includes, for example, the parameter targets 944 “whole machine”, 941 “feeder”, 942 “rod maker”, 943 “filter assembler”, and can include other parameter targets, for example, “paper supply”, “printer”. By selection of one of these parameter targets, only the parameters which concern the selected machine region are displayed in the list of contents 670. The parameter target 944 “whole machine” includes all of the other parameter targets of the target selection list 94. The parameter target “whole machine” therefore gives the experienced operator an overview and therefore quick access to the corresponding parameters, without having to perform additional operating steps or having to work through a plurality of hierarchically structured operating-region displays. For the less experienced user it may be clearer to confine the parameters displayed in the list of contents 670, for example, by selection of a machine region in the target selection list 94.

The target selection list assigned to the target selection area 91 concerns restriction of the parameters displayed in the list of contents 670 to certain types of parameter.

According to the above, the different parameter targets of the target selection list 94 are filters for the parameters to be displayed in the list of contents 670. It is possible to combine a selection of parameter targets of the target selection areas 90, 91, which leads to an AND restriction of the parameters displayed in the list of contents 670.

After selection of a target action, display of the target selection list 94 is deactivated again, so that only the target selection area 940 with the selected parameter target remains displayed. Preferably, only one target selection list can ever be activated at a time. If one of the target selection lists 94 is activated, the list of contents 670 may be partly concealed as a result (for example, in the layout shown in FIG. 23). Nevertheless the list of contents 670 remains at least partly visible. The user-friendliness is not impaired as a result, as display of the target selection list 94 is deactivated again after a selection and the list of contents is then unconcealed again; the list of contents 670 is therefore always concealed only partly and only for a short time. Alternatively the target selection areas 90, 91 can also be arranged in such a way that the list of contents 670 remains completely unconcealed even when the target selection list 94 is activated (in FIG. 23, for example, by display of the target selection list 94 above the target selection area 90).

According to the above, both the list of contents 670 and the at least one target selection area 90, 91 are arranged in the same operating-region display 67. Both the target selection area 90, 91 and the list of contents 670 are therefore visible to the operator in the operating-region display 67 at least partly together or simultaneously. The contents of the list of contents 670 change according to the parameter target selected in the target selection area 90, 91, without a possibly confusing change of screen display occurring. After selection of a parameter target, the target selection area 90, 91 remains visible in the operating-region display 67, so that reselection of another parameter target can be performed without effort. In this way an overview of the parameters to be performed at any given time or the relevant settings can be obtained quickly and clearly for different parameter targets. Preferably, the layout and design of the list of contents 670 and target selection area 90, 91 in the operating-region display 67 are essentially unchanged, so that the operator perceives the operating-region display 67 in any case with respect to the list of contents 670 and the target selection area 90, 91 as a common screen display.

The characteristics described in connection with FIGS. 22, 23 are not confined to adjustable machine parameters. They may easily be transferred, for example, to actions connected with machine operation, particularly in connection with a so-called settings assistant, in the form of a list of action contents, or messages occurring within a past interval of time in the form of a list of messages. In general, these characteristics are useful in particular in connection with large quantities of data which can be compiled in the form of a list. The subject of claims 32 to 39 is, if occasion arises, independent, i.e. can be claimed in a form only referring back to the introductory part of claim 1.

The “Configuration” main group that can be brought up by the button 274 preferably further includes operating-region displays which allow a change of brand to be carried out. These operating-region displays can be brought up, for example, by means of the button 663 in the operating-region display 66.

The “Configuration” main group preferably further includes operating-region displays concerning a test mode of the machine. For instance, by actuation of the button 664 in the operating-region display 66 the operating-region display 68 shown in FIG. 20 is brought up for the test mode. It shows buttons 680, 681, 682 for machine parts to be tested, and correspondingly marked images of the machine 683, 684, 685 assigned to them. The filter assembler, the rod maker and the feeder can therefore be tested individually or together. For example, by actuation of the button 681 in the operating-region display 68, the operating-region display 69 for the test mode of the filter assembler shown in FIG. 21 are brought up individually (region 695) and of the rod maker SE and feeder VE in combination (region 696). The machine parts can in each case be tested with or without material (buttons 690). By means of the buttons 691, individual machine devices can be switched on and off or adjusted separately. In the region 692, for example, the current production speed can be adjusted.

1. Display and operating unit for a machine in the tobacco-processing industry, with a visual display unit for the display of a graphic user interface consisting of a plurality of screen displays, and a computer which is designed to generate the graphic user interface by means of a computer program,
whereby essentially all the screen displays have at least the following regions:
an operating region that can be operated by the operator for the display of a plurality of different operating-region displays that can be selected by the operator, with machine- and/or product-related display and operating elements;
a message region for the display of machine- or product-related stop and warning messages,
characterized in that the screen displays have at least one further region which includes machine- and/or product-related display and/or operating elements concerning the production mode, display of the further region being independent of the respectively selected operating-region display of the operating region.

2. Display and operating unit according to claim 1, characterized in that the at least one further region includes a control region that can be operated by the operator with operating elements which can be operated for control of the machine.

3. Display and operating unit according to claim 2, characterized in that the control region includes two configurations for running machine and for standstill machine.

4. Display and operating unit according to claim 2, characterized in that the control region has an operating element for automatic starting of the whole machine from a standstill.

5. Display and operating unit according to claim 4, characterized in that the operating element for automatic starting of the whole machine as a function of the fulfilment of conditions necessary for starting the machine has a ready indicator.

6. Display and operating unit according to claim 2, characterized in that the control region has an operating element for adjustment of the machine speed.

7. Display and operating unit according to claim 2, characterized in that the control region has an operating element for automatic empty running of the machine in relation to product material.

8. Display and operating unit according to claim 2, characterized in that the control region has an operating element for switching secondary drives on and off.

9. Display and operating unit according to claim 2, characterized in that operating elements are assigned corresponding status indicating elements.

10. Display and operating unit according to claim 1, characterized in that the at least one further region has a production measurement data display region with display elements for the display of production measurement data measured by means of measuring devices in the machine.

11. Display and operating unit according to claim 10, characterized in that the production measurement data display region is arranged in the upper third of the screen.

12. Display and operating unit according to claim 10, characterized in that the production measurement data display region can be configured individually.

13. Display and operating unit according to claim 1, characterized in that the operating region, the message region and the or each further region are each in separate regions.

14. Display and operating unit according to claim 1, characterized in that the arrangement of the operating region, the message region and the or each further region is invariably predetermined for the operator during ordinary production.

15. Display and operating unit according to claim 1, characterized in that all operating-region displays are assigned to a plurality of groups of operating-region displays.

16. Display and operating unit according to claim 15, characterized in that each group of operating-region displays is assigned a main operating-region display.

17. Display and operating unit according to claim 15, characterized in that the operating-region displays are arranged hierarchically within a group.

18. Display and operating unit according to claim 15, characterized in that for each group a screen display can be stored as current.

19. Display and operating unit according to claim 15, characterized in that the operating region is assigned a group selection region with group selection fields which can be actuated for the selection of one group of operating-region displays, respectively.

20. Display and operating unit according to claim 19, characterized in that a group selection field is assigned a group of operating-region displays essentially concerning the production mode of the machine.

21. Display and operating unit according to claim 19, characterized in that a group selection field is assigned a group of operating-region displays essentially concerning faults, machine maintenance and/or starting up the machine.

22. Display and operating unit according to claim 19, characterized in that a group selection field is assigned a group of help operating-region displays for the display of an operator's manual in order of subject.

23. Display and operating unit according to claim 19, characterized in that a group selection field is assigned a group of operating-region displays essentially concerning shift management, parameter settings, changing brands, test running and/or machine maintenance.

24. Display and operating unit according to claim 1, characterized in that the message region is assigned a first message region for the display of a first message corresponding to the original reason for stopping in case of stopping of the machine.

25. Display and operating unit according to claim 1, characterized in that essentially every screen display has a line display region with display elements for machines of the corresponding production line that can be operated.

26. Display and operating unit according to claim 1, characterized in that the operating region is assigned a navigation region with navigation areas which can be actuated for bringing up desired operating-region displays.

27. Display and operating unit according to claim 1, characterized in that the operating region is assigned a navigation region which can be displayed temporarily on request, with navigation fields which can be actuated for bringing up desired operating-region displays.

28. Display and operating unit according to claim 27, characterized in that at least some of the navigation fields of the navigation region can be individually assigned to favoured operating-region displays.

29. Display and operating unit according to claim 1, characterized in that in at least one screen display can be displayed context help selection fields which are assigned to display or operating elements and the actuation of which leads to the display of respectively corresponding context help display elements.

30. Display and operating unit according to claim 1, characterized in that each operating-region display is assigned an operating priority for establishing authorisation for access to this operating-region display.

31. Display and operating unit according to claim 30, characterized in that the assignment of operating priorities to the operating-region displays can be configured individually.

32. Display and operating system according to claim 1, characterized in that all machine parameters adjustable by the operator can be displayed in an operating-region display.

33. Display and operating system according to claim 32, characterized in that all machine parameters adjustable by the operator are displayed in the form of a common list of contents.

34. Display and operating system according to claim 32, characterized in that the operating-region display includes at least one target selection field with a plurality of selectable parameter targets, the parameters displayed in the operating-region display being determined by the respectively selected parameter target.

35. Display and operating system according to claim 34, characterized in that a target selection field is provided for the selection of parameter targets in connection with different machine regions.

36. Display and operating system according to claim 34, characterized in that a target selection field is provided for the selection of parameter targets in connection with different types of parameter.

37. Display and operating system according to claim 32, characterized in that the parameters displayed in the operating-region display are arranged in an appropriate order.

38. Display and operating system according to claim 1, characterized in that all actions that can be performed by the operator and which are connected with machine operation can be displayed in one operating-region display.

39. Display and operating system according to claim 1, characterized in that all messages occurring within a past interval of time can be displayed in one operating-region display.

40. Display and operating method for a machine in the tobacco-processing industry, wherein a graphic user interface consisting of a plurality of screen displays is generated and displayed on a visual display unit, wherein in essentially all the screen displays at least the following regions are displayed:
an operating region that can be operated by the operator and in which a plurality of different operating-region displays that can be selected by the operator are displayed with machine- and/or product-related display and operating elements;
a message region that cannot be operated by the operator and in which machine- or product-related stop and warning messages are displayed,
characterized in that the screen displays have at least one further region, wherein in the further region are displayed machine- and/or product-related display and/or operating elements concerning the production mode, the further region being displayed independently of the respectively selected operating-region display of the operating region.
